(19) United States
(12) Patent Application Publication
(10) Pub. No.: US 2014/0186484 A1
(43) Pub. Date: Jul. 3, 2014

(54) Sealing system for a moved metal strip as well as a strip casting installation with such a sealing system

(71) Applicant: BERNDORF BAND GMBH, Berndorf (AT)

(72) Inventor: Franz Kager, Schwechat (AT)

(73) Assignee: Berndorf Band GmbH, Berndorf (AT)

(21) Appl. No.: 13/727,719

(22) Filed: Dec. 27, 2012

(51) Int. Cl. B29C 39/22; B29D 7/01

(52) U.S. Cl. CPC B29C 39/22; B29D 7/01
USPC 425/471; 277/345

(57) ABSTRACT

A sealing system is provided for a moved metal strip, which includes an elongated inflatable flexible body, a holder, into which the inflatable body is embedded, and an elongated body made of Teflon. The Teflon body is arranged on a side of the inflatable flexible body facing away from the holder and on a side facing away from the inflatable body has a sealing surface to the metal strip. Furthermore, an arrangement and a strip casting installation is provided with a metal strip and a sealing system of this kind.

The invention relates to a sealing system for a moved metal strip and an arrangement and a strip casting installation comprising such a metal strip and such a sealing system.

Moved metal strips are used according to the prior art for example for the production of film or also the production of artificial stone (“engineered Stone”). Here a more or less fluid or paste-like mass is applied to the metal strip and is worked into a product according to a defined process. The problem with this process is that in particular liquid or dust-like masses applied to the strip can drip down or fall down from the side of the strip, if the latter are not or cannot be converted rapidly enough into a sufficiently set film or a sufficiently set panel. This results in losses of material and messes up the production installation. In some circumstances a lot of effort is required to clean production installations messed up in this way and put them back into operation.

Therefore, one objective of the invention is to reduce the dropping or falling down of material applied onto the metal strip or avoid it completely if possible.

The problem of the invention is addressed by a sealing system for a moved metal strip comprising:
an elongated inflatable flexible body,
a holder, into which the said inflatable body is embedded, and
an elongated body made of Teflon, which is arranged, in particular is secured, onto a side of the inflatable, flexible body facing away from the holder, and which has a sealing surface on a side facing away from the inflatable body.

Furthermore, the problem of the invention is addressed by an arrangement, comprising a metal strip and a sealing system of this kind.

Lastly, the problem is also addressed by a strip casting installation, comprising an arrangement of the aforementioned type and a device for the application a material onto the metal strip.

By means of the proposed measures an effective sealing of the metal strip is achieved. On the one hand, the Teflon body can be pushed by means of the inflatable body against the metal strip, whereby a seal is formed between the Teflon body and metal strip, on the other hand, the friction is low because of the selected material despite the seal, so that excessive force cannot be applied either onto the Teflon body or the metal strip. As a result also the drive power for the metal strip can be kept low. By varying the pressure in the inflatable body in a simple manner a desired pressing force can also be adjusted. The seal can be configured to be fluid-tight for example by means of the sealing system, it can however also be configured to be gas-tight.

Further advantageous embodiments and developments of the invention are described in the subordinate claims as well as in the description in combination with the Figures.

It is advantageous if the sealing system comprises a compressed air supply system connected to the inflatable body, which system is set up to pressurize the inflatable body at a substantially constant pressure during operation. In this way the Teflon body is pressed at constant force onto the metal strip, whereby reproducible results are achieved with regard to the tightness and also with respect to a pulling force acting on the metal strip and necessary for the movement thereof. This also applies in case of wear of the Teflon body, as although the pressure in the inflatable body is constant, the volume therein can be variable. With increasing wear of the Teflon body the volume in the inflatable body increases accordingly, so that the Teflon body always lies with its sealing surface on the metal strip.

Furthermore, it is advantageous if the Teflon body is formed from a plurality of individual parts, which are joined together by means of lapping, in particular hook lapping, a tongue-and-groove joint or by means of a dovetail joint in a rod-like manner. In this way a plurality of individual rods can easily be joined together to form a longer rod. In particular, forming-fitting connections such as for example hook lapping or the dovetail joint are preferable, as Teflon is very difficult to adhere.

It is also advantageous if the Teflon body is formed from a plurality of individual parts which are welded together. In this way a plurality of individual rods can be joined together seamlessly to form a longer rod. In this way problems with sealing, which may occur in other joining methods, are easily avoided.

It is advantageous if the Teflon body is guided displaceably in the holder for the inflatable body. In this way, on the one hand unevenness and on the other also abrasion can be balanced out effectively, as the Teflon body can move towards the metal strip and can also move away from the latter. Furthermore, the securing of the Teflon body onto the inflatable body, which in some circumstances is difficult to achieve, can be omitted. Next to the sealing surface between the Teflon body and the metal strip a further sealing surface is formed between the Teflon body and the inflatable body.

In an advantageous embodiment of the sealing system the holder is formed by a

U-profile. In this way the holder can be produced easily, for example from a metal profile or a turned-over sheet.

In addition, it is advantageous if the Teflon body has a rectangular cross section. In this way the Teflon body can be produced easily and also has a flat sealing surface.

It is advantageous if the aforementioned arrangement in the edge area of the metal strip comprises sealing systems arranged and aligned parallel to its direction of movement. In this way it is possible to prevent materials applied to the metal strip, in particular fluids and powdered materials, running off the metal strip during the movement thereof.

However, it is also advantageous if the arrangement comprises a sealing system transverse to the direction of movement of the metal strip and spanning its width. In this way it is possible to prevent material applied onto the metal strip, in particular fluids and powdered materials, being distributed in an uncontrolled manner onto the metal strip during the movement of the latter.

It is particularly advantageous if the arrangement comprises a cavity, which is delimited on one side by the metal strip, wherein between the metal strip and at least one delimiting wall of the cavity a sealing system is arranged. In this way a cavity can be formed, by which a delimiting surface is formed by the metal strip and is moved thereby. In said cavity for example gases or liquids can be introduced which influence the strip itself and/or a material applied onto the metal strip. It would also be possible that a material applied onto the metal strip is hardened by a gas located in said cavity. For example, it is also possible however that there is water in such a cavity, in particular warm water.

It is advantageous if the cavity in the edge area of the metal strip is sealed by means of sealing systems of the said type and transversely thereto by sealing lips made of rubber or silicone. A good sealing effect can also be achieved by means of the wiping effect of such sealing lips.

A particularly advantageous arrangement is achieved if sealing systems are arranged opposite one another on an upper side and a lower side of the metal strip. In this case it is possible to prevent the metal strip bending away during the pressurizing of the inflatable body and thus making a seal more difficult.

It is advantageous in this case if the sealing systems arranged opposite one another are joined together tightly. In this way a cavity above the metal strip and a cavity below the metal strip are joined together tightly.

It is an advantage if both sealing systems arranged opposite one another have an inflatable body. In this way unevenness and in particular abrasion of the Teflon body can be compensated for without the metal strip having to be shaped in addition.

Lastly, it is also advantageous if only one of the two sealing systems arranged opposite one another has an inflatable body. In this way a simple structure of the arrangement is obtained.

For a better understanding of the invention the latter is explained in more detail with reference to the following figures.

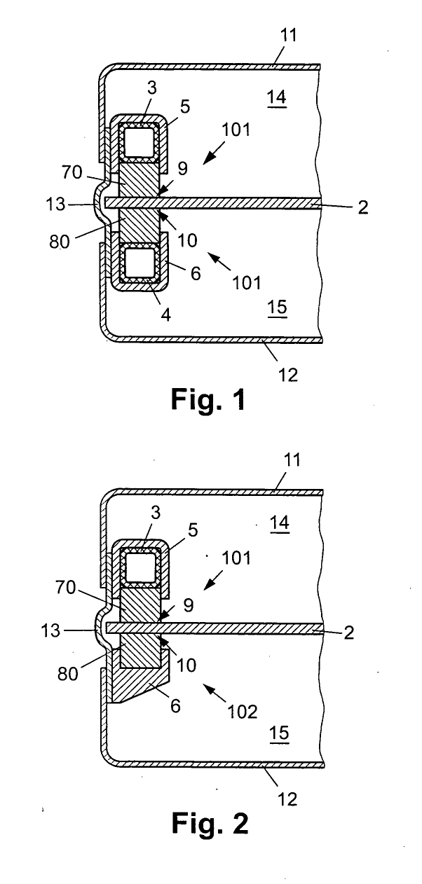

FIG. 1 shows a first schematically illustrated example of an arrangement with a sealing system and a moved metal strip in cross section;

FIG. 2 as FIG. 1, but only one sealing system is provided with an inflatable body;

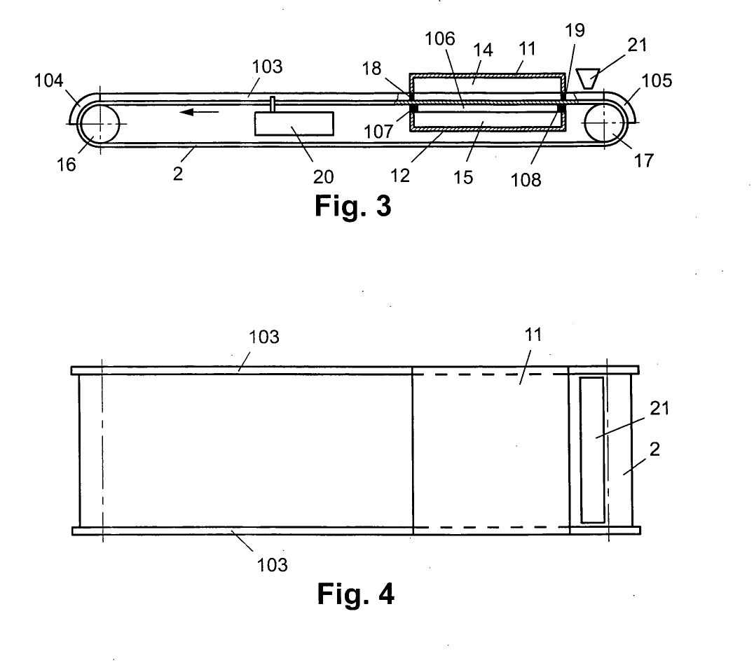

FIG. 3 shows a schematically represented arrangement with a sealing system and a moved metal strip in side view;

FIG. 4 shows the arrangement represented in FIG. 3 in plan view;

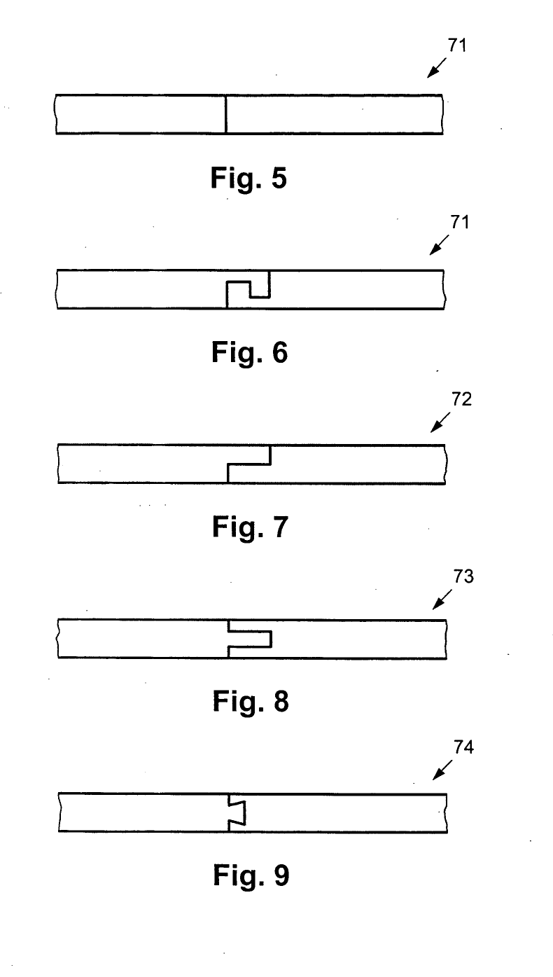

FIG. 5 shows a Teflon body, the individual parts of which are joined together in a rod-like manner by hook lapping, in side view;

FIG. 6 shows the Teflon body from FIG. 5 in plan view;

FIG. 7 shows a Teflon body, the individual parts of which are joined together in a rod-like manner by a simple overlapping, in plan view;

FIG. 8 shows a Teflon body, the individual parts of which are joined together in a rod-like manner by a tongue-and-groove joint, in plan view;

FIG. 9 shows a Teflon body, the individual parts of which are joined together in a rod-like manner by a dovetail joint, in plan view;

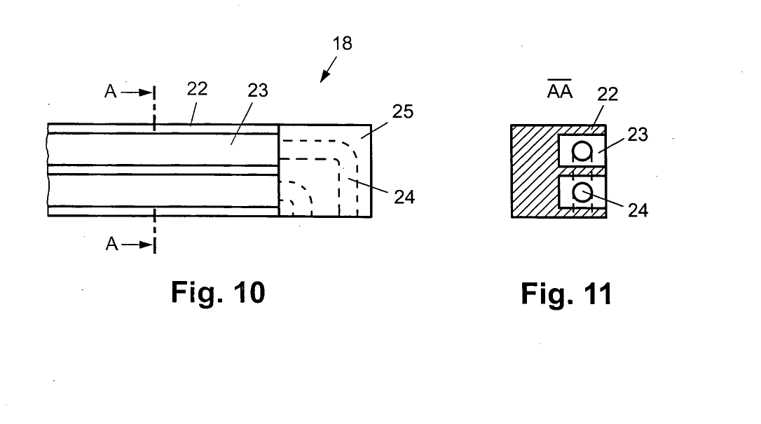

FIG. 10 shows an example of a multi-lip seal from below;

FIG. 11 shows the multi-lip seal of FIG. 10 in cross section.

First of all, it should be noted that in the variously described exemplary embodiments the same parts have been given the same reference numerals and the same component names, whereby the disclosures contained throughout the entire description can be applied to the same parts with the same reference numerals and same component names. Also details relating to position used in the description, such as e.g. top, bottom, side etc. relate to the currently described and represented figure and in case of a change in position should be adjusted to the new position. Furthermore, also individual features or combinations of features from the various exemplary embodiments shown and described can represent in themselves independent or inventive solutions.

FIG. 1 shows a first schematically represented example of an arrangement with two sealing systems 101 and a moved metal strip 2 in cross section. The sealing systems 101 each comprise two elongated inflatable flexible bodies 3, 4, holders 5, 6, in which the said inflatable bodies 3, 4 are embedded, and elongated bodies 70, 80 made of Teflon, which are arranged on sides of the inflatable flexible bodies 3, 4 facing away from the holders 5, 6. The Teflon bodies 70, 80 also comprise sealing surfaces 9, 10 on a side facing away from the inflatable body 3, 4 or on a side facing the metal strip 2.

In the present example the Teflon bodies 70, 80 are guided displaceably into the holders 5, 6 for the inflatable bodies 3, 4. In principle, it is therefore possible that the Teflon bodies 70, 80 simply lie on the inflatable bodies 3, 4. The securing of the Teflon bodies 70, 80 onto the inflatable bodies 3, 4 is not absolutely necessary in this case. Of course, it is also possible for the Teflon bodies 70, 80 to be secured onto the inflatable bodies 3, 4. The guiding of the Teflon bodies 70, 80 can then also be omitted.

By means of the possible movement of the Teflon bodies 70, 80 in the holders 5, 6 unevenness and also abrasion of the Teflon bodies 70, 80 can be compensated for. With increasing abrasion the Teflon bodies 70, 80 are pushed further out of the holders 5, 6.

In the present example the holders 5, 6 are formed by a U-profile. In this way the holders 5, 6 can be produced easily, for example from a metal profile or a turned-over sheet. Of course, the holders can also be made from a solid material (compare FIG. 2).

Furthermore, the Teflon bodies 70, 80 in the present example can have a rectangular cross section. In this way the Teflon bodies 70, 80 can also be produced easily and also have even sealing surfaces 9, 10.

In the arrangement shown in FIG. 1 the two sealing systems 101 are arranged opposite one another on an upper side and a lower side of the metal strip 2. In this way it is possible to prevent the metal strip 2 bending away from the inflatable bodies 3, 4 during the pressurizing of the latter and in this way sealing is made more difficult (cf. also FIG. 2). This is supported by the fact that both sealing systems 101 arranged opposite one another have inflatable bodies 3, 4.

In the arrangement shown in FIG. 1 the sealing systems 101 arranged opposite one another are joined together tightly by means of the bridge 13. In this way a cavity 14 above the metal strip 2, which is formed by the upper cover 11 and a cavity 15 below the metal strip 2, which is formed by the lower cover 12, are joined together tightly. Of course, it would also be possible to omit the bridge 13 and consequently provide only an upper cavity 14, only a lower cavity 15 or separate cavities 14 and 15.

In general, the seal obtained by means of the sealing system 101 can be configured to be fluid-tight or for example also gas-tight.

FIG. 2 shows a second schematically illustrated example of an arrangement with sealing system 101 and sealing system 102 as well as a moved metal strip 2 in cross section, which is very similar to the arrangement represented in FIG. 1. In contrast to the latter however only the upper sealing system 101 is equipped with an inflatable body 3, the lower sealing system 102 however has no inflatable body. This provides a comparatively simple structure of the arrangement.

FIG. 3 shows a further schematically illustrated example of an arrangement with sealing systems 103 . . . 108 and a moved metal strip 2 in side view, or in partial cross section. FIG. 4 shows the same arrangement in plan view.

The shown arrangement comprises sealing systems 103 . . . 106 arranged in the edge area of the metal strip 2 and aligned parallel to its direction of movement.

The sealing system 103 is located on the upper strand of the metal strip 2, the sealing systems 104 and 105 are arranged in the region of the guiding rollers 16 and 17 and the sealing system 106 is arranged on the lower strand of the metal strip 2, opposite the sealing system 103. By means of the chosen arrangement it is possible to prevent in particular materials applied to the metal strip 2, in particular liquids and powdered materials, from running or falling off the metal strip 2 during the movement thereof.

Furthermore, the arrangement shown in FIGS. 3 and 4 comprises sealing systems 107, 108 transversely to the direction of movement of the metal strip 2 and spanning its width. In this way a cavity 15 is formed which is delimited on one side by the metal strip 2, wherein sealing systems 106 . . . 108 are arranged between the metal strip 2 and the delimiting wall 12 of the cavity 15.

On the upper side of the metal strip 2 there is a further cavity 14 which is formed essentially by the metal strip 2 and the upper cover 11. In the edge area of the metal strip 2 the cavity 14 is sealed by means of sealing systems 103 and transversely thereto by sealing lips 18, 19 made of rubber or silicone.

Gases or fluids can be introduced into said cavities 14, 15 for example which influence the metal strip 2 itself and/or materials applied onto the metal strip 2. It would also be possible for a material on the metal strip 2 to be hardened by a gas in the cavity 14. It would also be possible to have water in the cavity 15, in particular warm water, or also steam for heating the metal strip 2. For example spraying jets directed towards the metal strip 2 can be arranged in the cavity 15, which spray warm water onto the metal strip 2. Backflowing warm water can also be collected in the cavity 15. Lastly, it would also be possible to have a cleaning device for the metal strip 2 in the cavity 14. This can comprise for example high-pressure spraying jets and a cleaning brush.

The selection of sealing systems 18, 19 for the upper cavity 14 provided transversely to the direction of movement of the metal strip 2 and the sealing systems 107, 108 for the lower cavity 15 is given purely by way of example. Of course, the sealing systems 107, 108 can also be used for the upper cavity 15 or both cavities 14 and 15. At the same time the sealing lips 18, 19 made of rubber or silicone can also be used for the lower cavity 15 or both cavities 14 and 15. Advantageously, multi-lip seals can also be used for the said purpose (cf. also FIGS. 10 and 11).

Lastly, FIG. 3 shows a device for the application of material in the form of a funnel 21. By means of this funnel 21 the material can be applied onto the metal strip 2, which is required for example for the production of film or artificial stone.

A further feature of the arrangement shown in FIGS. 3 and 4 is that the sealing systems 103 . . . 108, in particular their inflatable bodies 3, 4, are connected to a compressed air supply system 20, which is set up to pressurize the inflatable bodies 3, 4 during operation at an essentially constant pressure. In this way the Teflon bodies 70, 80 are pushed at constant pressure onto the metal strip 2, whereby reproducible results are achieved with respect to the seal and also with respect to the pulling force acting on the metal strip 2 and necessary for movement. This also applies in case of wear to the Teflon bodies 70, 80, as although the pressure in the inflatable bodies 3, 4 is constant, the volume therein can be variable. With increasing wear of the Teflon bodies 70, 80 the volume in the inflatable bodies 3, 4 increases, so that the Teflon body 70, 80 always lies on the metal strip 2 with the sealing surfaces 9, 10,

Depending on the length/breadth of the metal strip 2 or their sealing systems 101 . . . 108 it may be necessary to form the Teflon bodies 70, 80 from a plurality of different parts. FIGS. 5 and 6 also show a Teflon body 71 formed from a plurality of individual parts which are joined together in a rod-like manner by means of hook lapping. FIG. 5 shows the Teflon body 71 inside view, FIG. 6 in plan view. By means of the chosen connection the individual parts are not only joined together but also a kind of labyrinth seal is formed.

FIG. 7 shows a Teflon body 72, which is formed from a plurality of individual parts, which are joined together in a rod-like manner by means of lapping.

FIG. 8 shows a Teflon body 73 formed from a plurality of individual parts, which are joined together in a rod-like manner by means of a tongue-and-groove joint. In FIG. 8 the tongue is worked directly into one of the individual parts, it would also be possible to use an external tongue.

Lastly, FIG. 9 shows a Teflon body 74 formed from a plurality of individual parts, which are joined together in a rod-like manner by means of a dovetail joint.

In general, by means of the types of connection shown in FIGS. 5 to 9 a plurality of individual rods can be joined together easily to form a longer rod. It is an advantage in particular to have form-fitting connections such for example hook lapping (FIGS. 5 and 6) or dovetail joints (FIG. 9), as Teflon can only be adhered with difficulty.

Alternatively or in addition to the shown connection methods it is possible for a Teflon body 70 . . . 74, 80 to be formed from individual parts which are welded together. In this way a plurality of individual rods can be joined together seamlessly to form a longer rod. In this way possible sealing problems can be avoided more easily.

FIGS. 10 and 11 show how the seals 18 and 19 could be configured. The seal 18 is shown by way of example, in FIG. 10 from below and in FIG. 11 in cross section AA. Cavities 23 between the lips 22 of the multi-lip seal 18 are each joined in this example to a run-off 24, which is arranged in an edge piece 25 of the multi-lip seal 18. By way of these measures a particularly good drying of the metal strip 2 can be achieved, as ahead of the lips 22 arranged downstream in the direction of movement of the metal strip 2 no fluid can build up over a long period. The metal strip 2 thus becomes successively drier when passing the individual lips 22. The multi-lip seal 18 can be configured in one piece or also consist of a plurality of parts. For example the edge piece 25 can be a separate part. It would also be possible to insert individual sealing lips 22 into a main body.

Thus in FIGS. 10 to 11 an arrangement is shown which comprises a multi-lip seal 18 arranged transversely to the direction of movement of the metal strip 2, which seal in particular is arranged downstream of a device for the application of a fluid onto the metal strip 2 (e.g. spraying jets in the cavity 15) in the main direction of movement of the metal strip 2, whereby cavities 23 between the lips of the multi-lip seal 18 are connected to a run-off 24.

The exemplary embodiments show possible embodiment variants of a sealing system 101 . . . 108 according to the invention or an arrangement/strip casting installation comprising a metal strip 2 and such a sealing system 101 . . . 108, whereby it should be noted at this point that the invention is not restricted to the embodiment variants shown in particular, but rather various different combinations of the individual embodiment variants are also possible and this variability, due to the teaching on technical procedure, lies within the ability of a person skilled in the art in this technical field. Thus all conceivable embodiment variants, which are made possible by combining individual details of the embodiment variants shown and described, are also covered by the scope of protection.

In particular, it should be noted that the shown sealing systems 101 . . . 108 or arrangements in reality can also comprise more or fewer components than represented.

Finally, as a point of formality, it should be noted that for a better understanding of their structure the sealing systems 101 . . . 108 and/or arrangements and the components thereof have not been represented true to scale in part and/or have been enlarged and/or reduced in size.

The problem addressed by the independent solutions according to the invention can be taken from the description.

### LIST OF REFERENCE NUMERALS

101 . . . 108 sealing system
2 metal strip
3 inflatable flexible body
4 inflatable flexible body
5 holder
6 holder
70 . . . 74 Teflon body
80 Teflon body
9 sealing surface
10 sealing surface
11 upper cover
12 lower cover
13 bridge
14 upper cavity
15 lower cavity
16 guiding roller
17 guiding roller
18 sealing lip
19 sealing lip
20 compressed air supply system
21 device for the application of material (funnel)
22 sealing lip
23 cavity
24 run-off
25 edge piece

1. A sealing system (101 . . . 108) for a moved metal strip (2), comprising
an elongated inflatable flexible body (3, 4),
a holder (5, 6), into which the said inflatable body (3, 4) is embedded, and
an elongated body (70 . . . 74, 80) made of Teflon, which is arranged on a side of the inflatable flexible body (3, 4) facing away from the holder (5, 6) and which on a side facing away from the inflatable body (3, 4) comprises a sealing surface (9, 10).

2. The sealing system (101 . . . 108) as claimed in claim 1, wherein a compressed air supply system (17) connected to the inflatable body (3, 4) is provided which is set up to pressurize the inflatable body (3, 4) during operation with a substantially constant pressure.

3. The sealing system (101 . . . 108) as claimed in claim 1, wherein the Teflon body (70 . . . 74, 80) is formed from a plurality of individual parts which are fitted together and/or are welded together.

4. The sealing system (101 . . . 108) as claimed in claim 1, wherein the Teflon body (70 . . . 74, 80) is guided displaceably in the holder (5, 6) for the inflatable body (3, 4).

5. The sealing system (101 . . . 108) as claimed in claim 1, wherein the holder (5, 6) is formed by a U-profile.

6. An arrangement comprising a moved metal strip (2) and a sealing system (101 . . . 108) acting on the metal strip (2) as claimed in claim 1.

7. The arrangement as claimed in claim 6, wherein at least one sealing system (101 . . . 106) is provided arranged in the edge area of the metal strip (2) and aligned parallel to its direction of movement.

8. The arrangement as claimed in claim 6, wherein a sealing system (107, 108) is provided extending transversely to the direction of the movement of the metal strip (2) and spanning its width.

9. The arrangement as claimed in claim 6, wherein a cavity (14, 15) is provided, which is delimited on one side by the metal strip (2), wherein between the metal strip (2) and at least one delimiting wall (11, 12) of the cavity wall (14, 15) a sealing system (101 . . . 108) is arranged.

10. The arrangement as claimed in claim 9, wherein the cavity (14, 15) in the edge area of the metal strip (2) is sealed by means of sealing systems (103 . . . 108) and is sealed transversely thereto by sealing lips (18, 19) made of rubber or silicone.

11. The arrangement as claimed in claim 6, wherein sealing systems (103, 106) are arranged opposite one another on a top side and a bottom side of the metal strip (2).

12. The arrangement as claimed in claim 11, wherein the sealing systems (103, 106) arranged opposite one another are connected to one another tightly.

13. The arrangement as claimed in claim 11, wherein the two sealing systems (103, 106) arranged opposite one another have an inflatable body (3, 4).

14. The arrangement as claimed in claim 11, wherein only one of the two opposite sealing systems (103, 106) has an inflatable body (3, 4).

15. A strip casting installation comprising an arrangement as claimed in claim 6 as well as a device for the application of a material onto the metal strip (1).
